(19) United States
(12) Patent Application Publication
(10) Pub. No.: US 2011/0168631 A1
(43) Pub. Date: Jul. 14, 2011

(54) METHODS AND APPARATUSES FOR WATER FILTRATION USING POLYARYLETHER MEMBRANES

(75) Inventors: Gary William Yeager, Rexford, NY (US); Daniel Steiger, Basking Ridge, NJ (US); Yanshi Zhang, Solon, OH (US)

(73) Assignee: GENERAL ELECTRIC COMPANY, Schenectady, NY (US)

(21) Appl. No.: 13/051,227

(22) Filed: Mar. 18, 2011

Related U.S. Application Data
(63) Continuation-in-part of application No. 11/611,697, filed on Dec. 15, 2006.

(51) Int. Cl. B01D 71/06; C08G 75/23; C02F 1/44; B01D 69/12; B01D 71/42

(52) U.S. Cl. 210/651; 528/173; 210/650; 210/654; 210/490; 210/500.33

(57) ABSTRACT

Membranes for use in methods and apparatuses for water filtration are composed of at least one polyarylethernitrile membrane having structural units of formula 1

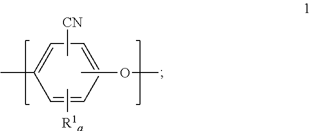

and
structural units of formula 2, 3, or a combination thereof

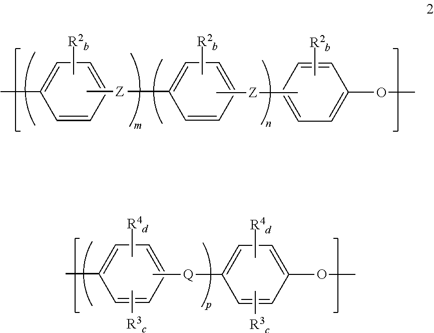

wherein
   Z is independently a direct bond, O, S, CH₂, SO, SO₂, CO, RPO, CH₂, alkenyl, alkynyl, a C₁-C₁₂ aliphatic radical, a C₆-C₁₂ cycloaliphatic radical, a C₆-C₁₂ aromatic radical or a combination thereof, and wherein R is equal to C₆-C₁₂ aryl radical;
   Q is a direct bond, O, S, CH₂, alkenyl, alkynyl, a C₁-C₁₂ aliphatic radical, a C₃-C₁₂ cycloaliphatic radical, a C₆-C₁₂ aromatic radical or a combination thereof;
   R¹, R², R³ and R⁴ are independently H, halo, nitro, a C₁-C₁₂ aliphatic radical, a C₃-C₁₂ cycloaliphatic radical, a C₆-C₁₂ aromatic radical, or a combination thereof;
   a is 0, 1, 2 or 3;
   b, c, and d are independently 0, 1, 2, 3 or 4; and
   p, m and n are independently 0 or 1; and
   Q and Z are different.

### CROSS-REFERENCE TO RELATED APPLICATIONS

This application is a continuation-in-part to U.S. patent application Ser. No. 11/611,697 filed Dec. 15, 2006; the disclosure of which are incorporated herein by reference in their entirety.

### BACKGROUND

The invention relates generally to methods and apparatuses for water filtration.

In recent years, porous membranes, either in hollow fiber or flat sheet configurations have been employed in many water filtration systems including ultrafiltration (UF) and reverse osmosis (RO). The polymers used in these membranes are known for their chemical resistance, mechanical and thermal stability, and hydrophilicity

Polysulfones have been used in ultrafiltration and reverse osmosis membranes because of their excellent mechanical strength and ductility enabling fabrication of robust microporous membranes. However the hydrophilicity of these membranes is generally not optimal for use in aqueous separations since they are subject to poor wettability and fouling. Further improvements in membrane hydrophilicity have been achieved by polymer blending, fabricating the porous polysulfone membrane in the presence of small amounts of hydrophilic polymers such as polyvinylpyrollidone (PVP). Alternatively hydrophilicity has been achieved via functionalization of the polymer backbone and introduction of carboxyl, nitrile or polyethylene glycol functionality, which may also provide chemical resistance and good mechanical properties. Despite advances in the preparation of polysulfone compositions displaying enhanced hydrophilicity, further improvements and refinements in the performance characteristics of membranes comprising polysulfones are required.

As mentioned above, to improve their hydrophilicity, polysulfones have been blended with hydrophilic polymers such as polyvinylpyrollidone (PVP). However, since PVP is water-soluble it is slowly leached from the porous polymer matrix creating product variability. Notwithstanding, the method of blending polysulfone with a hydrophilic polymer such as PVP is a commercially used process for producing hydrophilic porous polysulfone membranes.

Thus porous membranes possessing excellent thermal and mechanical properties are desired. In addition, polymers capable of being fabricated into porous membranes that possess sufficient hydrophilicity to obviate the need for blending with hydrophilic polymers is also desired. Finally polymers which are more hydrophilic than polysulfone yet not water soluble, which may induce hydrophilicity to the porous polysulfone membranes without undesirably leaching from the membrane are also sought. Furthermore microporous hydrophilic polysulfone membranes of the present invention have utility in the production of novel composite reverse osmosis membranes produced by interfacial condensation of electrophilic and nucleophilic monomers on the face of the membrane so as to produce a thin, discriminating layer often 100-500 nm thick, at the surface of a microporous support layer.

### BRIEF DESCRIPTION

In one aspect, the present invention relates to a water filtration apparatus comprising a polyarylethernitrile membrane having structural units of formula 1

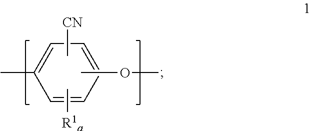

and structural units of formula 2, 3, or a combination thereof

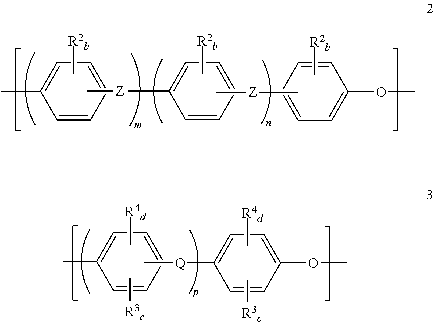

wherein
a. Z is independently a direct bond, O, S, CH₂, SO, SO₂, CO, RPO, CH₂, alkenyl, alkynyl, a C₁-C₁₂ aliphatic radical, a C₆-C₁₂ cycloaliphatic radical, a C₆-C₁₂ aromatic radical or a combination thereof, and wherein R is equal to C₆-C₁₂ aryl radical;
b. Q is a direct bond, O, S, CH₂, alkenyl, alkynyl, a C₁-C₁₂ aliphatic radical, a C₃-C₁₂ cycloaliphatic radical, a C₆-C₁₂ aromatic radical or a combination thereof;
c. R¹, R², R³ and R⁴ are independently H, halo, nitro, a C₁-C₁₂ aliphatic radical, a C₃-C₁₂ cycloaliphatic radical, a C₆-C₁₂ aromatic radical, or a combination thereof;
d. a is 0, 1, 2 or 3;
e. b, c, and d are independently 0, 1, 2, 3 or 4; and
f. p, m and n are independently 0 or 1; and
g. Q and Z are different

In another aspect, the present invention relates to methods for water filtration said method comprising contacting a feed stream with a porous membrane comprising a polyarylethernitrile copolymer of the present invention and collecting water as the permeate.

In another aspect, the present invention relates to a reverse osmosis water filtration apparatus comprising a first membrane comprising a polyarylethernitrile copolymer of the present invention and a second membrane a second membrane deposited on the surface of the first membrane and having a thickness of about 1 to about 500 nanometers.

In another aspect, the present invention relates to methods for water filtration, said method comprising contacting a feed stream with an apparatus comprising a first and second membrane. The first membrane comprising a polyarylethernitrile copolymer of the present invention and the second membrane, deposited on the surface of the first membrane, and having a thickness of about 1 to about 500 nanometers.

### DETAILED DESCRIPTION

In one aspect, the present invention relates to porous membranes composed of polyarylethernitrile copolymers having structural units of formula 1

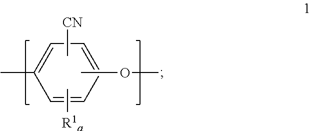

and structural units of formula 2, 3, or a combination thereof

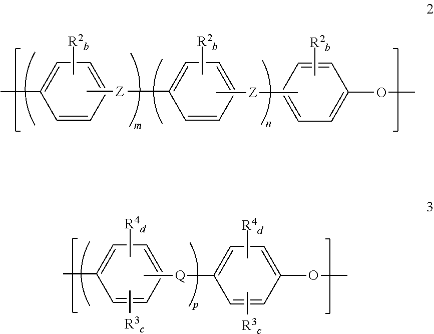

wherein
a. Z is independently a direct bond, O, S, CH₂, SO, SO₂, CO, RPO, CH₂, alkenyl, alkynyl, a C₁-C₁₂ aliphatic radical, a C₆-C₁₂ cycloaliphatic radical, a C₆-C₁₂ aromatic radical or a combination thereof, and wherein R is equal to C₆-C₁₂ aryl radical;
b. Q is a direct bond, O, S, CH₂, alkenyl, alkynyl, a C₁-C₁₂ aliphatic radical, a C₃-C₁₂ cycloaliphatic radical, a C₆-C₁₂ aromatic radical or a combination thereof;
c. R¹, R², R³ and R⁴ are independently H, halo, nitro, a C₁-C₁₂ aliphatic radical, a C₃-C₁₂ cycloaliphatic radical, a C₆-C₁₂ aromatic radical, or a combination thereof;
d. a is 0, 1, 2 or 3;
e. b, c, and d are independently 0, 1, 2, 3 or 4; and
p, m and n are independently 0 or 1; and
Q and Z are different

In a particular embodiment, the polyarylethernitrile copolymer includes structural units of formula 1A with structural units of formula 2A, 3A, or a combination thereof

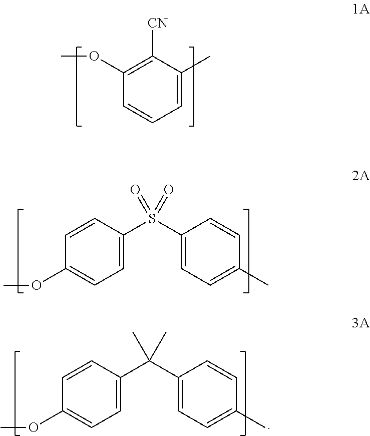

Polyarylethernitriles are typically solvent resistant polymers with high glass transition temperature and/or melting point. The polyarylethernitrile copolymer may be a block copolymer or a random copolymer, the difference being that a block copolymer contains blocks of monomers of the same type that may be arranged sequencially. A random copolymer contains a random arrangement of the multiple monomers making up the copolymer.

For example, in one embodiment the polyarylethernitrile copolymer may be a block copolymer comprising structural units of formula I

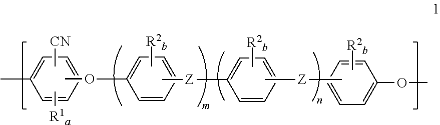

wherein Z is a direct bond, O, S, CH₂, SO, SO₂, CO, phenylphosphine oxide or a combination thereof;
R¹ and R² are independently H, halo, cyano, nitro, a C₁-C₁₂ aliphatic radical, a C₃-C₁₂ cycloaliphatic radical, a C₆-C₁₂ aromatic radical, or a combination thereof;
a is 0, 1, 2 or 3;
b is 0, 1, 2, 3 or 4; and
m and n are independently 0 or 1.

The polyarylethernitrile block copolymers and random polyarylethernitrile copolymers may be produced by reacting at least one dihalobenzonitrile with at least one aromatic dihydroxy compound in a polar aprotic solvent in the presence of an alkali metal compound, and optionally, in the presence of catalysts. Other dihalo aromatic compounds in addition to the dihalobenzonitrile may also be used.

Some examples of the dihalobenzonitrile monomers useful for preparing the polyarylethernitrile block copolymers and random polyarylethernitrile copolymers of the present invention include 2,6-dichlorobenzonitrile, 2,6-difluorobenzonitrile, 2,5-dichlorobenzonitrile, 2,5-difluorobenzonitrile 2,4-dichlorobenzonitrile, and 2,4-difluorobenzonitrile.

Exemplary dihalo aromatic compounds that may be used include
4,4′-bis(chlorophenyl)sulfone, 2,4′-bis(chlorophenyl)sulfone,
2,4-bis(chlorophenyl)sulfone, 4,4′-bis(fluorophenyl)sulfone,
2,4′-bis(fluorophenyl)sulfone, 2,4-bis(fluorophenyl)sulfone,
4,4′-bis(chlorophenyl)sulfoxide, 2,4′-bis(chlorophenyl)sulfoxide,
2,4-bis(chlorophenyl)sulfoxide, 4,4′-bis(fluorophenyl)sulfoxide,
2,4′-bis(fluorophenyl)sulfoxide, 2,4-bis(fluorophenyl)sulfoxide,
4,4′-bis(fluorophenyl)ketone, 2,4′-bis(fluorophenyl)ketone,
2,4-bis(fluorophenyl)ketone, 1,3-bis(4-fluorobenzoyl)benzene,
1,4-bis(4-fluorobenzoyl)benzene, 4,4′-bis(4-chlorophenyl)phenylphosphine oxide,
4,4′-bis(4-fluorophenyl)phenylphosphine oxide,
4,4′-bis(4-fluorophenylsulfonyl)-1,1′-biphenyl,
4,4′-bis(4-chlorophenylsulfonyl)-1,1′-biphenyl,
4,4′-bis(4-fluorophenylsulfoxide)-1,1′-biphenyl, and
4,4′-bis(4-chlorophenylsulfoxide)-1,1′-biphenyl.

Suitable aromatic dihydroxy compounds that may used to make the polyarylethernitrile block copolymers and random polyarylethernitrile copolymers include 4,4′-dihydroxyphenyl sulfone, 2,4′-dihydroxyphenyl sulfone, 4,4′-dihydroxyphenyl sulfoxide, 2,4′-dihydroxyphenyl sulfoxide, bis(3,5-dimethyl-4-hydroxyphenyl) sulfoxide, bis(3,5-dimethyl-4-hydroxyphenyl) sulfone, 4,4-(phenylphosphinyl)diphenol, 4,4′-oxydiphenol, 4,4′-thiodiphenol, 4,4′-dihydroxybenzophenone, 4,4′ dihydroxyphenylmethane, hydroquinone, resorcinol, 5-cyano-1,3-dihydroxybenzene, 4-cyano-1,3,-dihydroxybenzene, 2-cyano-1,4-dihydroxybenzene, 2-methoxyhydroquinone, 2,2′-biphenol, 4,4′-biphenol, 2,2′-dimethylbiphenol 2,2′,6,6′-tetramethylbiphenol, 2,2′,3,3′,6,6′-hexamethylbiphenol, 3,3′,5,5′-tetrabromo-2,2′6,6′-tetramethylbiphenol, 4,4′-isopropylidenediphenol (bisphenol A), 4,4′-isopropylidenebis(2,6-dimethylphenol) (teramethylbisphenol A), 4,4′-isopropylidenebis(2-methylphenol), 4,4′-isopropylidenebis(2-allylphenol), 4,4′-isopropylidenebis(2-allyl-6-methylphenol), 4,4′(1,3-phenylenediisopropylidene)bisphenol (bisphenol M), 4,4′-isopropylidenebis(3-phenylphenol), 4,4′-isopropylidene-bis(2-phenylphenol), 4,4′-(1,4-phenylenediisoproylidene)bisphenol (bisphenol P), 4,4′-ethylidenediphenol (bisphenol E), 4,4′-oxydiphenol, 4,4′-thiodiphenol, 4,4′-thiobis(2,6-dimethylphenol), 4,4′-sulfonyldiphenol, 4,4′-sulfonylbis(2,6-dimethylphenol) 4,4′-sulfinyldiphenol, 4,4′-hexafluoroisoproylidene)bisphenol (Bisphenol AF), 4,4′-hexafluoroisoproylidene) bis(2,6-dimethylphenol), 4,4′-(1-phenylethylidene)bisphenol (Bisphenol AP), 4,4′-(1-phenylethylidene)bis(2,6-dimethylphenol), bis(4-hydroxyphenyl)-2,2-dichloroethylene (Bisphenol C), bis(4-hydroxyphenyl)methane (Bisphenol-F), bis(2,6-dimethyl-4-hydroxyphenyl)methane, 2,2-bis(4-hydroxyphenyl)butane, 3,3-bis(4-hydroxyphenyl)pentane, 4,4′-(cyclopentylidene)diphenol, 4,4′-(cyclohexylidene)diphenol (Bisphenol Z), 4,4′-(cyclohexylidene)bis(2-methylphenol), 4,4′-(cyclododecylidene)diphenol, 4,4′-(bicyclo[2.2.1]heptylidene)diphenol, 4,4′-(9H-fluorene-9,9-diyl)diphenol, 3,3′-bis(4-hydroxyphenyl)isobenzofuran-1(3H)-one, 1-(4-hydroxyphenyl)-3,3′-dimethyl-2,3-dihydro-1H-inden-5-ol, 1-(4-hydroxy-3,5-dimethylphenyl)-1,3,3′,4,6-pentamethyl-2,3-dihydro-1H-inden-5-ol, 3,3,3′,3′-tetramethyl-2,2′,3,3′-tetrahydro-1,1′-spirobi[indene]-5,6′-diol (Spirobiindane), dihydroxybenzophenone (bisphenol K), thiodiphenol (Bisphenol S), bis(4-hydroxyphenyl)diphenyl methane, bis(4-hydroxyphenoxy)-4,4′-biphenyl, 4,4′-bis(4-hydroxyphenyl)diphenyl ether, 9,9-bis(3-methyl-4-hydroxyphenyl)fluorene, and N-phenyl-3,3-bis-(4-hydroxyphenyl)phthalimide.

In particular embodiments, one of a or b may be 0. In specific embodiments, both a and b are 0, and the polyarylethernitrile block copolymers and random polyarylethernitrile copolymers are composed of unsubstituted structural units, except for the nitrile substituent.

A basic salt of an alkali metal compound may be used to effect the reaction between the dihalo and dihydroxy aromatic compounds, and is not particularly limited so far as it can convert the aromatic dihydroxy compound to its corresponding alkali metal salt. Exemplary compounds include alkali metal hydroxides, such as, but not limited to, lithium hydroxide, sodium hydroxide, potassium hydroxide, rubidium hydroxide, and cesium hydroxide; alkali metal carbonates, such as, but not limited to, lithium carbonate, sodium carbonate, potassium carbonate, rubidium carbonate, and cesium carbonate; and alkali metal hydrogen carbonates, such as but not limited to lithium hydrogen carbonate, sodium hydrogen carbonate, potassium hydrogen carbonate, rubidium hydrogen carbonate, and cesium hydrogen carbonate. Combinations of compounds may also be used to effect the reaction.

Some examples of the aprotic polar solvent that may be effectively used to make the polyarylethernitrile include N,N-dimethylformamide, N,N-diethylformamide, N,N-dimethylacetamide, N,N-diethylacetamide, N,N-dipropylacetamide, N,N-dimethylbenzamide, N-methyl-2-pyrrolidone (NMP), N-ethyl-2-pyrrolidone, N-isopropyl-2-pyrrolidone, N-isobutyl-2-pyrrolidone, N-n-propyl-2-pyrrolidone, N—N-butyl-2-pyrrolidone, N-cyclohexyl-2-pyrrolidone, N-methyl-3-methyl-2-pyrrolidone, N-ethyl-3-methyl-pyrrolidone, N-methyl-3,4,5-trimethyl-2-pyrrolidone, N-methyl-2-piperidone, N-ethyl-2-piperidone, N-isopropyl-2-piperidone, N-methyl-6-methyl-2-piperidone, N-methyl-3-ethylpiperidone, dimethylsulfoxide (DMSO), diethylsulfoxide, sulfolane, 1-methyl-1-oxo sulfolane, 1-ethyl-1-oxo sulfolane, 1-phenyl-1-oxo sulfolane, N,N′-dimethylimidazolidinone (DMI), diphenylsulfone, and combinations thereof. The amount of solvent to be used is typically an amount that is sufficient to dissolve the dihalo and dihydroxy aromatic compounds.

The reaction may be conducted at a temperature ranging from about 100° C. to about 300° C., ideally from about 120° C. to about 200° C., more preferably about 150° C. to about 200° C. Often when thermally unstable or reactive groups are present in the monomer and wish to be preserved in the polymer, temperatures in the regime of about 100° C. to about 120° C., in other embodiments from about 110° C. to about 145° C. is preferred. The reaction mixture is often dried by addition to the initial reaction mixture of, along with the polar aprotic solvent, a solvent that forms an azeotrope with water. Examples of such solvents include toluene, benzene, xylene, ethylbenzene and chlorobenzene. After removal of residual water by azeotropic drying, the reaction is carried out at the elevated temperatures described above. The reaction is typically conducted for a time period ranging from about 1 hour to about 72 hours, ideally about 1 hour to about 10 hours. Alternatively the bisphenol is converted in an initial step to its dimetallic phenolate salt and isolated and dried. The anhydrous dimetallic salt is used directly in the condensation polymerization reaction with a dihaloaromatic compound in a solvent, either a halogenated aromatic or polar aprotic, at temperatures from about 120° C. to about 300° C. The reaction may be carried out under ordinary pressure or pressurized conditions.

When halogenated aromatic solvents are used phase transfer catalysts may be employed. Suitable phase transfer catalysts include hexaalkylguanidinium salts and bis-guanidinium salts. Typically the phase transfer catalyst comprises an anionic species such as halide, mesylate, tosylate, tetrafluoroborate, or acetate as the charge-balancing counterion(s). Suitable guanidinium salts include those disclosed in U.S. Pat. Nos. 5,132,423; 5,116,975 and 5,081,298. Other suitable phase transfer catalysts include p-dialkylamino-pyridinium salts, bis-dialkylaminopyridinium salts, bis-quaternary ammonium salts, bis-quaternary phosphonium salts, and phosphazenium salts. Suitable bis-quaternary ammonium and phosphonium salts are disclosed in U.S. Pat. No. 4,554,357. Suitable aminopyridinium salts are disclosed in U.S. Pat. No. 4,460,778; U.S. Pat. No. 4,513,141 and U.S. Pat. No. 4,681,949. Suitable phosphazenium salts are disclosed in U.S. patent application Ser. No. 10/950,874. Additionally, in certain embodiments, the quaternary ammonium and phosphonium salts disclosed in U.S. Pat. No. 4,273,712 may also be used.

The dihalobenzonitrile or mixture of dihalobenzonitriles or mixture of dihalobenzonitrile and a dihalo aromatic compound may be used in substantially equimolar amounts relative to the dihydroxy aromatic compounds or mixture of dihydroxy aromatic compounds used in the reaction mixture. The term “substantially equimolar amounts” means a molar ratio of the dihalobenzonitrile compound(s) to dihydroxy aromatic compound(s) is about 0.85 to about 1.2, preferably about 0.9 to about 1.1, and most preferably from about 0.98 to about 1.02.

After completing the reaction, the polymer may be separated from the inorganic salts, precipitated into a non-solvent and collected by filtration and drying. The drying may be carried out either under vacuum and/or at high temperature, as is known commonly in the art. Examples of non-solvents include water, methanol, ethanol, propanol, butanol, acetone, methyl ethyl ketone, methyl isobutyl ketone, gamma.-butyrolactone, and combinations thereof. Water and methanol are the preferred non-solvents.

The glass transition temperature, T_{g}, of the polymer typically ranges from about 120° C. to about 280° C. in one embodiment, and ranges from about 140° C. to about 200° C. in another embodiment. In some specific embodiments, the T_{g} ranges from about 140° C. to about 190° C., while in other specific embodiments, the T_{g} ranges from about 150° C. to about 180° C.

The polyarylethernitrile may be characterized by number average molecular weight (Mₙ) and weight average molecular weight (M_{w}). The various average molecular weights Mₙ, and M_{w} are determined by techniques such as gel permeation chromatography, and are known to those of ordinary skill in the art. In one embodiment, the Mₙ, of the polymer may be in the range from about 10,000 grams per mole (g/mol) to about 1,000,000 g/mol. In another embodiment, the Mₙ, ranges from about 15,000 g/mol to about 200,000 g/mol. In yet another embodiment, the Mₙ, ranges from about 20,000 g/mol to about 100,000 g/mol. In still a further embodiment the Mn ranges from about 40,000 g/mol to about 80,000 g/mol.

In some embodiments, the membrane comprises a polyarylethernitrile blended with at least one additional polymer, in particular, blended with or treated with one or more agents known for promoting biocompatibility. The polymer may be blended with the polyarylethernitrile to impart different properties such as better heat resistance, biocompatibility, and the like. Furthermore, the additional polymer may be added to the polyarylethernitrile during the membrane formation to modify the morphology of the phase inverted membrane structure produced upon phase inversion, such as asymmetric membrane structures. In addition, at least one polymer that is blended with the polyarylethernitrile may be hydrophilic or hydrophobic in nature. In some embodiments, the polyarylethernitrile is blended with a hydrophilic polymer.

The hydrophilicity of the polymer blends may be determined by several techniques known to those skilled in the art. One particular technique is that of determination of the contact angle of a liquid such as water on the polymer. It is generally understood in the art that when the contact angle of water is less than about 40-50°, the polymer is considered to be hydrophilic, while if the contact angle is greater than about 80°, the polymer is considered to be hydrophobic.

One hydrophilic polymer that may be used is polyvinylpyrrolidone (PVP). In addition to, or instead of, polyvinylpyrrolidone, it is also possible to use other hydrophilic polymers which are known to be useful for the production of membranes, such as polyoxazoline, polyethyleneglycol, polypropylene glycol, polyglycolmonoester, copolymers of polyethyleneglycol with polypropylene glycol, water-soluble cellulose derivatives, polysorbate, polyethylene-polypropylene oxide copolymers and polyethyleneimines. PVP may be obtained by polymerizing a N-vinylpyrrolidone using standard addition polymerization techniques known in the art. One such polymerization procedure involves the free radical polymerization using initiators such as azobisisobutyronitrile (AIBN), optionally in the presence of a solvent. PVP is also commercially available under the tradenames PLASDONE® from ISP COMPANY or KOLLIDON® from BASF. Use of PVP in hollow fiber membranes is described in U.S. Pat. Nos. 6,103,117, 6,432,309, 6,432,309, 5,543,465, incorporated herein by reference.

When the membrane comprises a blend of the polyarylethernitrile and PVP, the blend comprises from about 1% to about 80% polyvinylpyrrolidone in one embodiment, preferably 5-50%, and from about 2.5% to about 25% polyvinylpyrrolidone based on total blend components in another embodiment.

PVP may be crosslinked by known methods prior to use to avoid eluting of the polymer with the medium. U.S. Pat. No. 6,432,309, and U.S. Pat. No. 5,543,465, the disclose methods for crosslinking PVP. Some exemplary methods of crosslinking include, but are not limited to, exposing it to heat, radiation such as X-rays, ultraviolet rays, visible radiation, infrared radiation, electron beams; or by chemical methods such as, but not limited to, treating PVP with a crosslinker such as potassium peroxodisulfate, ammonium peroxopersulfate, at temperatures ranging from about 20° C. to about 80° C. in aqueous medium at pH ranges of from about 4 to about 9, and for a time period ranging from about 5 minutes to about 60 minutes. The extent of crosslinking may be controlled, by the use of a crosslinking inhibitor, for example, glycerin, propylene glycol, an aqueous solution of sodium disulfite, sodium carbonate, and combinations thereof.

The hydrophilicity of the polymer blends may be determined by several techniques known to those skilled in the art. One particular technique is that of determination of the contact angle of a liquid such as water on the polymer. It is generally understood in the art that materials exhibiting lower contact angles are considered to be more hydrophilic.

In other embodiments, the polyarylethernitrile is blended with another polymer. Examples of such polymers that may be used include polysulfone, polyether sulfone, polyether urethane, polyamide, polyether-amide, and polyacrylonitrile.

In one particular embodiment, the at least one additional polymer contains an aromatic ring in its backbone and a sulfone moiety as well. These polymers include polysulfones, polyether sulfones or polyphenylenesulfones or copolymers therefrom. Such polymers are described in U.S. Pat. Nos. 4,108,837, 3,332,909, 5,239,043 and 4,008,203. Examples of commercially available polyethersulfones are RADEL R® (a polyethersulfone made by the polymerization of 4,4′-dichlorodiphenylsulfone and 4,4′-biphenol), RADEL A® (PES) and UDEL® (a polyethersulfone made by the polymerization of 4,4′-dichlorodiphenylsulfone and bisphenol A), both available from Solvay Chemicals.

Without being bound to theory, it is understood that water filtration works on the principle of the diffusion of solutes across a porous membrane. During filtration, a feed stream that is to be purified is contacted with a membrane. The feed stream may comprise brackish water, seawater, industrial water for electronic, pharmaceutical, or food contact applications, or industrial wastewater. After contact and passage through the membrane, purified water may be collected as the permeate.

In one embodiment, the membranes are water separation membranes and may be used for desalinating brackish and sea water, water softening, production of ultrapure water for electronics and pharmaceutical industries and industrial wastewater purification for food and beverage, electroplating and metal finishing, textiles and laundry, petroleum and petrochemical, and pulp and water industries.

In certain applications, a filtration apparatus generally comprises a plurality of membranes that are stacked or bundled together to form a module. The water stream to be purified is fed into a feed line, which is then allowed to pass through filtration lines, while coming in contact with the membranes.

In certain embodiments, such an apparatus may be an ultrafiltration or microfiltration system wherein a normal osmosis process, wherein the water stream to be purified moves from an area of low solute concentration, through a membrane to an area of high solute concentration. For example ultra filtration may be used for purifying feed water to remove impurities, including suspended solids. The membranes may also be desirable to use in these applications due to low protein binding of the membrane, which reduces fouling.

The membrane may be designed to have specific pore sizes so that solutes having sizes greater than the pore sizes may not be able to pass through. A pore size refers to the radius of the pores in the active layer of the membrane. In one embodiment, the pore size ranges from about 0.5 to about 100 nm. In another embodiment, the pore size ranges from about 4 to about 50 nm. In another embodiment, the pore size ranges from about 4 to about 25 nm. In another embodiment, the pore size ranges from about 4 to about 15 nm. In another embodiment, the pore size ranges from about 5.5 to about 9.5 nm.

The membranes for use in the methods and apparatus of the present invention may be made by processes known in the art. Several techniques for membrane formation are known in the art, some of which include, but are not limited to: dry-phase separation membrane formation process in which a dissolved polymer is precipitated by evaporation of a sufficient amount of solvent to form a membrane structure; wet-phase separation membrane formation process in which a dissolved polymer is precipitated by immersion in a non-solvent bath to form a membrane structure; dry-wet phase separation membrane formation process which is a combination of the dry and the wet-phase formation processes; thermally-induced phase-separation membrane formation process in which a dissolved polymer is precipitated or coagulated by controlled cooling to form a membrane structure. Further, after the formation of a membrane, it may be subjected to a membrane conditioning process or a pretreatment process prior to its use in a separation application. Representative processes may include thermal annealing to relieve stresses or pre-equilibration in a solution similar to the feed stream the membrane will contact.

In one embodiment, the membranes may be prepared by phase inversion. The phase inversion process includes 1) vapor-induced phase separation (VIPS), also called “dry casting” or “air casting”; 2) liquid-induced phase separation (LIPS), mostly referred to as “immersion casting” or “wet casting”; and 3) thermally induced phase separation (TIPS), frequently called “melt casting”. The phase inversion process can produce integrally skinned asymmetric membranes. Alternatively, the porous polyarylether having amide functionality can be used as a support for a thin film membrane ideally cast or interfacially polymerized onto its surface.

For the phase inversion process, the polyarylether having amide functionality may be dissolved in a solvent, such as antisolvents or polar aprotic solvents, which are defined above. In one embodiment, the polar aprotic solvent may be N,N-dimethylformamide, N,N-dimethylacetamide or 1-methyl-2-pyrrolidinone. In one embodiment, the antisolvent compounds may be water, alcohols, such as methanol, ethanol, isopropanol or diethylene glycol, or ketones, such as acetone, methylethylketone or isobutyl ketone. Both the polar aprotic solvent and anti-solvent may be used as binary or ternary systems in combination with other solvents, antisolvents or additional polymers, such as hydrophilic polymers (e.g., polyvinylpyrollidone or polyethylene glycol), which effect the morphology of the phase inverted membrane. The morphology can be dictated by the type, amount and molecular weight of the polyarylether having amide functionality.

The membranes may be crosslinked to provide additional support. The membranes may be crosslinked by incorporating a membrane into a module, filled with an aqueous solution in which 100 to 1,000 ppm of sodium disulfite and 50 to 500 ppm sodium carbonate are dissolved, and irradiated with gamma rays. The dose of gamma rays is set appropriately taking the objective degree of cross-linking into consideration. In one embodiment, a dose of gamma rays is in the range of about 10 kGy to about 100 kGy.

The membrane may be designed to have specific pore sizes so that solutes having sizes greater than the pore sizes may not be able to pass through. A pore size refers to the radius of the pores in the active layer of the membrane. In one embodiment, the pore size ranges from about 0.5 to about 100 nm. In another embodiment, the pore size ranges from about 4 to about 50 nm. In another embodiment, the pore size ranges from about 4 to about 25 nm. In another embodiment, the pore size ranges from about 4 to about 15 nm. In another embodiment, the pore size ranges from about 5.5 to about 9.5 nm.

In other embodiments, apparatus may be a reverse osmosis (RO) system wherein the water stream may be pumped under pressure, thus causing a pressure differential between a filtered and an unfiltered stream. During contact, the concentration gradient between the filtered and unfiltered stream and the membrane pore sizes causes selected solutes to diffuse through the membranes. In certain apparatuses, the membranes may be contained within and integral to the main purification apparatus, such as in a membrane bioreactor. In other apparatuses, the membranes may be contained in a separate unit and may be used in an intermediate pumping or filtration step.

In certain embodiments the RO system may be fabricated by using the aforementioned polyarylethernitrile copolymer membrane as part of a thin film composite (TFC) membrane. In such a construction the polyarylethernitrile copolymer acts as a porous support membrane for a polymer thin film cast onto its surface.

The thin film composite (TFC) membranes that may be prepared by a process according to the present invention are composed of a separating functional layer formed on the polyarylethernitrile copolymer membrane. The separating functional layer is thin in order to maximize membrane flux performance and the polyarylethernitrile copolymer membrane provides mechanical strength. As such, the polyarylethernitrile copolymer membrane acts as a porous base support.

The separating functional polymer may be prepared by condensation of electrophilic and nucleophilic monomers. Electrophiles are molecules which contain a partially polarized covalent bond which may form new covalent bonds by reacting with nucleophiles, molecules which contain a lone pair of electrons. The new covalent bond is preferentially formed between the most electropositive atom of the electrophile and the atom in the nucleophile having pairs of electrons with greatest electron density. Electrophilic monomers are monomer molecules which contain at least two partially polarized bonds, producing an atom within the monomer molecule possessing at least partial positive charge. Nucleophilic monomers are monomer molecules, which contain at least two pairs of electrons capable of forming a covalent bond with an electrophile.

Preparation of the TFC membrane by adherence of the discriminating polymer layer to the supporting polymer may be conducted using interfacial polymerization of one or more nucleophilic with one or more electrophilic monomers. Interfacial polymerization may be used to form the TFC membrane and includes contacting an aqueous solution of one or more nucleophilic monomers with the porous polyarylethernitrile supporting membrane; followed by coating an organic solution, generally in an aliphatic solvent, containing one or more electrophilic monomers. At the interface of the two solution layers, which lies near the surface of the porous support, a thin film polymer is formed from condensation of the electrophilic and nucleophilic monomers and is adherent to polyarylethernitrile copolymer membrane. The rate of thin film formation may be accelerated by heating or addition of catalysts. For example a polyacid halide monomer on contact with a polyamine monomer may reacts on the surface of the polyarylethernitrile copolymer membrane to afford a TFC membrane comprising a polyamide disposed on the surface of the polyarylethernitrile copolymer. Suitable monomers useful in the present invention are described below.

As described above, the membrane may comprise a polymer having an amine group. The polymer may be produced by interfacial polymerization. Interfacial polymerization includes a process widely used for the synthesis of thin film membranes for reverse osmosis, hyperfiltration, and nanofiltration. Interfacial polymerization includes coating a first solution, generally aqueous, of one or more nucleophilic monomers onto a porous base support; followed by coating a second solution, generally in an aliphatic solvent, containing one or more electrophilic monomers. The second solution is immiscible with the first solution. At the interface of the two solution layers, which lies near the surface of the porous base support, a thin film polymer is formed from condensation of the electrophilic and nucleophilic monomers and is adherent to the porous base support. The rate of thin film formation may be accelerated by heating or addition of catalysts. In certain embodiments the thickness of the thin film is from about 1 to about 500 nanometers.

Examples of nucleophilic monomers include, but are not limited to, amine containing monomers such as polyethylenimines; cyclohexanediamines; 1,2-diaminocyclohexane; 1,4-diaminocyclohexane; piperazine; methyl piperazine; dimethylpiperazine (e.g. 2,5-dimethyl piperazine); homopiperazine; 1,3-bis(piperidyl)propane; 4-aminomethylpiperazine; cyclohexanetriamines (e.g. 1,3,5-triaminocyclohexane); xylylenediamines (o-, m-, p-xylenediamine); phenylenediamines; (e.g. m-phenylene diamine and p-phenylenediamine, 3,5-diaminobenzoic acid, 3,5-diamonsulfonic acid); chlorophenylenediamines (e.g. 4- or 5-chloro-m-phenylenediamine); benzenetriamines (e.g. 1,3,5-benzenetriamine, 1,2,4-triaminobenzene); bis(aminobenzyl)aniline; tetraminobenzenes; diaminobiphenyls (e.g. 4,4,′-diaminobiphenyl; tetrakis(aminomethyl)methane; diaminodiphenylmethanes; N,N′-diphenylethylenediamine; aminobenzamides (e.g. 4-aminobenzamide, 3,3′-diaminobenzamide; 3,5-diaminobenzamide; 3,5-diaminobenzamide; 3,3′5,5′-tetraminobenzamide); either individually or in any combinations thereof.

Particularly useful nucleophilic monomers for the present invention include m-phenylenediamine, p-phenylenediamine, 1,3,5-triaminobenzene, piperazine, 4-aminomethylpiperidine, and either individually or in any combinations thereof. More particularly, nucleophilic monomer useful in the present invention includes m-phenylenediamine.

Examples of electrophilic monomers include, but are not limited to, acid halide-terminated polyamide oligomers (e.g. copolymers of piperazine with an excess of isophthaloyl chloride); benzene dicarboxylic acid halides (e.g. isophthaloyl chloride or terephthaloyl chloride); benzene tricarboxylic acid halides (e.g. trimesoyl chloride or trimellitic acid trichloride); cyclohexane dicarboxylic acid halides (e.g. 1,3-cyclohexane dicarboxylic acid chloride or 1,4-cyclohexane dicarboxylic acid chloride); cyclohexane tricarboxylic acid halides (e.g. cis-1,3,5-cyclohexane tricarboxylic acid trichloride); pyridine dicarboxylic acid halides (e.g. quinolinic acid dichloride or dipicolinic acid dichloride); trimellitic anhydride acid halides; benzene tetra carboxylic acid halides (e.g. pyromellitic acid tetrachloride); pyromellitic acid dianhydride; pyridine tricarboxylic acid halides; sebacic acid halides; azelaic acid halides; adipic acid halides; dodecanedioic acid halides; toluene diisocyanate; methylenebis(phenyl isocyanates); naphthalene diisocyanates; bitolyl diisocyanates; hexamethylene diisocyanate; phenylene diisocyanates; isocyanato benzene dicarboxylic acid halides (e.g. 5-isocyanato isophthaloyl chloride); haloformyloxy benzene dicarboxylic acid halides (e.g. 5-chloroformyloxy isophthaloyl chloride); dihalosulfonyl benzenes (e.g. 1,3-benzenedisulfonic acid chloride); halo sulfonyl benzene dicarboxylic acid halides (e.g. 3-chloro sulfonyl isophthaloyl chloride); 1,3,6-tri(chloro sulfonyl)naphthalene; 1,3,7tri(chloro sulfonyl)napthalene; trihalo sulfonyl benzenes (e.g. 1,3,5-trichloro sulfonyl benzene); and cyclopentanetetracarboxylic acid halides, either individually or in any combinations thereof.

Particular electrophilic monomers include, but are not limited to, trimesoyl chloride, trimellitic acid trichloride, terephthaloyl chloride, isophthaloyl chloride, 5-isocyanato isophthaloyl chloride, 5-chloroformyloxy isophthaloyl chloride, 5-chloro sulfonyl isophthaloyl chloride, 1,3,6-(trichlorosulfonyl)naphthalene, 1,3,7-(trichlorosulfonyl)napthalene, 1,3,5-trichlorosulfonyl benzene, either individually or in any combinations thereof. More particular electrophilic monomers include trimesoyl chloride or trimellitic acid trichloride.

The interfacial polymerization reaction may be carried out at a temperature ranging from about 5° C. to about 100° C., preferably from about 10° C. to about 40° C. to produce an interfacial polymer membrane. Examples of interfacial polymers produced thereform include polyamide, polysulfonamide, polyurethane, polyurea, and polyesteramides, either individually or in any combinations thereof.

In one example, for illustration and not limitation, the polyarylethernitrile copolymer membrane acts as a porous base support has a surface pore size in the approximate range from about 50 Angstroms to about 5000 Angstroms. The pore sizes should be sufficiently large so that a permeate solvent can pass through the support without reducing the flux of the composite. However, the pores should not be so large that the permselective polymer membrane will either be unable to bridge or form across the pores, or tend to fill up or penetrate too far into the pores, thus producing an effectively thicker membrane than 500 nanometers. U.S. Pat. No. 4,814,082 (W. J. Wrasidlo) and U.S. Pat. No. 4,783,346 (S. A. Sundet) are illustrative of methods of choosing and preparing a porous base support for interfacial TFC (thin film composite) membrane formation.

In certain embodiments, once the membranes are formed, the membranes may undergo a pretreatment to add to filtration effectiveness. For example, in certain applications a disinfectant chemical may be applied to kill pathogens, which may pass through the membranes, included viruses and bacteria. In certain applications chlorine dioxide may be used. In other applications sodium hypochlorite may be used including contacting the membranes with aqueous solutions of sodium hypochlorite.

### DEFINITIONS

The present invention may be understood more readily by reference to the following detailed description of preferred embodiments of the invention and the examples included therein. In the following specification and the claims which follow, reference will be made to a number of terms which shall be defined to have the following meanings:

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, furanyl, thienyl, naphthyl, and biphenyl radicals. The aromatic aryl radical may be substituted. Substituents include a member or members selected from the group consisting of F, Cl, Br, I, alkyl, aryl, amide, sulfonamide, hydroxyl, aryloxy, alkoxy, thioalkoxy, thioaryloxy, carbonyl, sulfonyl, carboxylate, carboxylic ester, sulfone, phosphonate, sulfoxide, urea, carbamate, amine, phosphinyl, nitro, cyano, acylhydrazide, hydrazide, imide, imine, amidates, amidines, oximes, peroxides, diazo, and azide.

As used herein the term “aliphatic radical” refers to an organic radical having a valence of at least one consisting of a linear or branched array of atoms both cyclic and non-cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” organic radicals substituted with a wide range of functional groups such as alkyl groups, alkenyl groups, alkynyl groups, F, Cl, Br, I, amide, sulfonamide, hydroxyl, aryloxy, alkoxy, thioalkoxy, thioaryloxy, carbonyl, sulfonyl, carboxylate, carboxylic ester, sulfone, phosphonate, sulfoxide, urea, carbamate, amine, phosphinyl, nitro, cyano, acylhydrazide, hydrazide, imide, imine, amidates, amidines, oximes, peroxides, diazo, azide, and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. The polymer may contain or be further functionalized with hydrophilic groups, including hydrogen-bond acceptors that have overall, electrically neutral charge.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values that are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

It is understood that in the formation of the polymer blends used as membrane, either only or with a second membrane for RO, that the nitrile group of the polyethernitrile may react with hydroxyl or amino groups in the blended hydrophilic polymer or the interfacially produced polymer to form covalent linkages which may result in improved compatibilization and stabilization of the polymeric membranes. In such a process, washing out of the hydrophilic polymers during the filtration process, as may occur for PVP, would be mitigated. In the case of RO membranes, binding of the second membrane to the support membrane would further stabilize the system.

### EXAMPLES

### General Methods and Procedures

Chemicals were purchased from Aldrich and Sloss Industries and used as received, unless otherwise noted. All reactions with air- and/or water-sensitive compounds were carried out under dry nitrogen using standard Schlenk line techniques. NMR spectra were recorded on a Bruker Avance 400 (¹H, 400 MHz) spectrometer and referenced versus residual solvent shifts. Molecular weights are reported as number average (Mₙ) or weight average (M_{w}) molecular weight and were determined by gel permeation chromatography (GPC) analysis on a Perkin Elmer Series 200 instrument equipped with UV detector. Polystyrene molecular weight standards were used to construct a broad standard calibration curve against which polymer molecular weights were determined. The temperature of the gel permeation column (Polymer Laboratories PLgel 5 μm MIXED-C, 300×7.5 mm) was 40° C. and the mobile phase was chloroform with isopropanol (3.6% v/v). Polymer thermal analysis was performed on a Perkin Elmer DSC7 equipped with a TAC7/DX thermal analyzer and processed using Pyris Software. Glass transition temperatures were recorded on the second heating scan.

Contact angle measurements were taken on a VCA 2000 (Advanced Surface Technology, Inc.) instrument using VCAoptima Software for evaluation. Polymer films were obtained from casting a thin film from an appropriate solution (DMAc, chloroform) onto a clean glass slide and evaporation of the solvent. Advancing contact angles with water (73 Dynes/cm) were determined on both sides of the film (facing air and facing glass slide). Consistently lower values were obtained on the side facing the glass slide presumably due to the smoother surface.

For reverse osmosis membranes permeability and sodium chloride rejection are measured. The permeability of membranes may be characterized in terms of their A-value. This value is represented by the volume of water permeated divided by the multiple of the membrane area, time and net driving pressure used in the test. Typical units are such that a membrane possessing an A-value of 1 permeates 1 (cm³ water/(cm² membrane)(sec-atm) or 1 cm/sec-atm. In the context of the present invention, the A values given have the following unit designation: cm/(sec.atm) at 25° C. The net driving pressure used is equal to the average trans-membrane pressure minus the feed-permeate osmotic pressure difference. The % rejection calculated from

100*([NaCl]_{original}−[NaCl]ₚₑᵣₘₑₐₜₑ/[NaCl]_{original}.

RO membranes are tested using 5.08 cm diameter membrane disks installed into “dead-end” high pressure filtration cells (Sterlitech Corporation, Kent, Wash., USA) with magnetic stirrers. The membranes were flushed with deionized water at 16 atm of pressure and the filtration cell charged with 100 ml of 2000 ppm aqueous NaCl solution after an initial flush of permeate a sample was collected for analysis. The salt concentration of the original salt solution and permeate were determined from their electrical conductivity.

### Example 1

### Polycyanosulfone (Homopolymer)

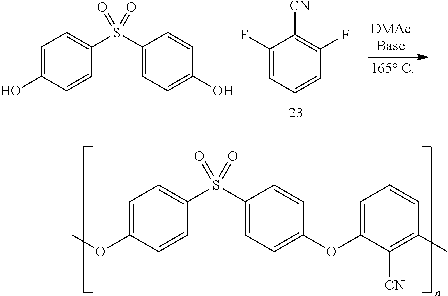

Under nitrogen atmosphere N,N-dimethylacetamide (DMAc) (500 mL) and K₂CO₃ (400.08 g, 2.8949 mol) were charged into a 5000 mL-reactor. Bisphenol-S (361.90 g, 1.4460 mol) was added and rinsed in with DMAc (1100 mL). Over the course of 2 days about 2350 mL of toluene was added in portions and distilled out to dry the reaction mixture. Then, 2,6-difluorobenzonitrile (196.85 g, 1.4151 mol) plus more toluene (525 mL) was added. During the subsequent polymerization toluene kept distilling at a constant rate (˜2.5 ml/min). After 5 h, the Mw=80 k (PDI=1.6) was high enough and the mixture was diluted with DMAc (3200 mL) and the polymer was drained from the reactor, precipitated into water, filtered and rinsed with water. The resulting white fluffy powder was reslurried with water, filtered and slurried again with methanol. After filtration and drying in the vacuum oven 450 g (89% yield) of a fluffy white powder was obtained.

DSC: T_{g}=227° C.

TGA: 1-2% weight loss up to 450° C., decomposition starts at 460° C., 52% wt loss at 900° C.

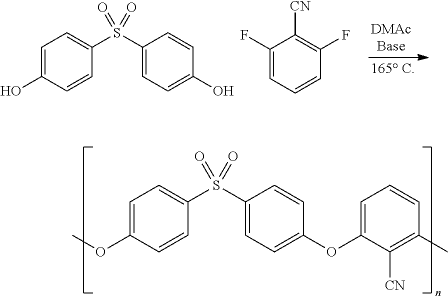

Contact angle: 74° on top, 43° facing glass slide

The cyanosulfone DS430 was dissolved in NMP to produce a 20 weight % solids. To one solution there was added 20-weight % Polyvinylpyrollidone (Mn=100,000). Both solutions were cast onto a glass plate using a 10 mil-casting knife. Porous membranes were produced by immersing the films immediately into water.

### Example 2

### Hydrophobic/Hydrophilic Block Copolymers

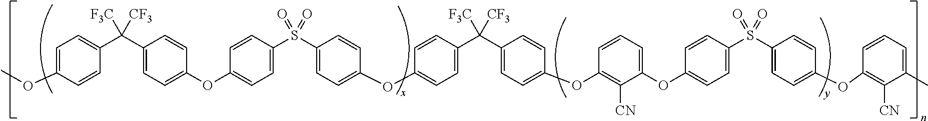

Hexafluorobisphenol A, 2,2-bis(4-hydroxyphenyl)hexafluoropropane, (4.6419 g, 13.8055 mmol), bis(4-fluorophenyl)sulfone (2.8076 g, 11.0424 mmol), K₂CO₃ (5.7271 g, 41.4389 mmol), dimethyl acetamide (DMAc) (34.6 g) and toluene (18.3 g) were combined in the reaction flask under Argon and immersed into a hot oil bath (150° C.). Under mechanical stirring toluene/water was distilled off and the progress of the polymerization was monitored by GPC. After 6 h, a weight average molecular weight of approximately 10,000 was reached and bisphenol S, bis(4-hydroxyphenyl)sulfone, (3.4550 g, 13.8048 mmol), 2,6-difluorobenzonitrile (2.3050 g, 16.5703 mmol) and some more toluene (15 mL) were added to the mixture. During the course of the polymerizations three more aliquots of toluene (5 mL each) were added to facilitate the removal of water. After a temporary molecular weight drop right after the addition of the second pair of monomers the molecular weight sharply increased until it leveled off at around Mw=41,000.

The polymerization mixture was diluted with DMAc (81 g) and then precipitated in water (2×700 mL), filtered, rinsed with methanol and vacuum oven dried.

### DSC: T_{g}=198° C.

Contact angle: 92° on top, 70° facing glass slide

### Example 3

### Hydrophobic/Hydrophilic Block Copolymer, Longer Blocks

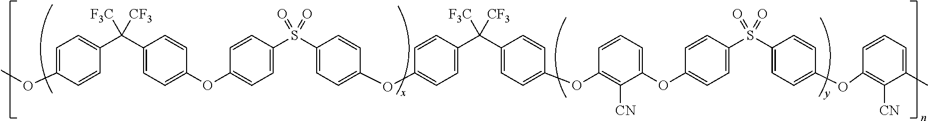

Hexafluorobisphenol A, 2,2-bis(4-hydroxyphenyl)hexafluoropropane, (5.0546 g, 15.0330 mmol), bis(4-fluorophenyl)sulfone (3.4405 g, 13.5316 mmol), K₂CO₃ (6.2400 g, 45.1501 mmol), dimethyl acetamide (DMAc) (41 g) and toluene (23 mL) were combined in the reaction flask under nitrogen and immersed into a hot oil bath (155° C.). Under mechanical stirring toluene/water was distilled off and the progress of the polymerization was monitored by GPC. After 6 h, a weight average molecular weight of approximately 14,000 was reached and bisphenol S, bis(4-hydroxyphenyl)sulfone, (3.6960 g, 14.7678 mmol), 2,6-difluorobenzonitrile (2.2677 g, 16.3021 mmol) and some more toluene were added to the mixture. During the course of the polymerizations more aliquots of toluene were added to facilitate the removal of water. After the addition of the second pair of monomers the molecular weight sharply increased until it leveled off at around Mw=68,000 (PDI=6.1).

The polymerization mixture was cooled to 80° C., diluted with DMAc (92 g) and then precipitated in water (2×800 mL), filtered, rinsed with ethanol and vacuum oven dried.

### DSC: T_{g}=208° C.

Contact angle: 90° on top, 59° facing glass slide

### Example 4

### Hydrophobic/Hydrophilic Block Copolymer

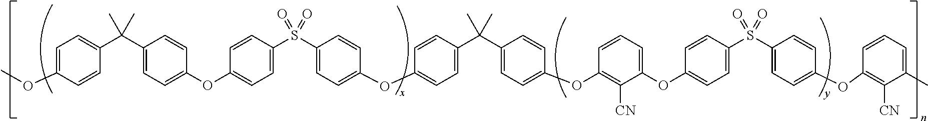

Bisphenol A, 2,2-bis(4-hydroxyphenyl)propane, (25.6187 g, 0.1122 mol), bis(4-chlorophenyl)sulfone (27.6595 g, 0.09632 mol), K₂CO₃ (33.4053 g, 0.2417 mol), dimethylsulfoxide (DMSO) (190.5 g) and toluene (100 mL) were combined in the reaction flask under nitrogen and immersed into a hot oil bath (170° C.). Under mechanical stirring toluene/water was distilled off and the progress of the polymerization was monitored by GPC. Two more aliquots of toluene (50 mL each) were added after 49 and 195 minutes to facilitate the removal of water. After 7 h, a constant weight average molecular weight of approximately 8,500 was reached. The mixture was cooled to room temperature¹ and bisphenol S, bis(4-hydroxyphenyl)sulfone, (12.0352 g, 0.048088 mol), 2,6-difluorobenzonitrile (8.9192 g, 0.06412 mol) and more toluene (100 mL) were added to the mixture. The mixture was slowly heated back to 170° C. to make sure the distillation of toluene/water was not too vigorous. After the addition of the second pair of monomers the molecular weight sharply increased until it leveled off at around Mw=190,000 (PDI=12.4).

The polymerization mixture was cooled and diluted with DMSO (355 mL) and then precipitated into water, filtered, rinsed with water and vacuum oven dried at 70° C. A light yellow fluffy powder was obtained (63.7 g). The latter was redissolved in chloroform (595 g) and precipitated into MeOH (2×2000 mL) to give an almost white precipitate. After air-drying for 24 h and vacuum oven (at 70° C.) drying for 3 days 53.2 g (82%) of an off-white powder were obtained.

### DSC: T_{g}=202° C.

Contact angle: 70° (top); 46° (facing glass)

### Example 5

### Hydrophobic/Hydrophilic Block Copolymer

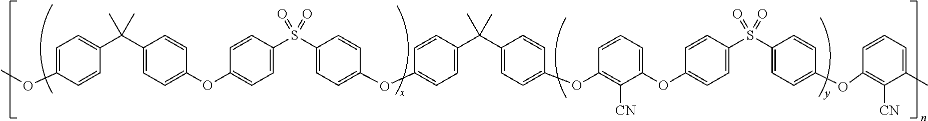

Bisphenol A, 2,2-bis(4-hydroxyphenyl)propane, (15.0089 g, 65.7447 mmol), bis(4-chlorophenyl)sulfone (14.1515 g, 49.2799 mmol), K₂CO₃ (34.1051 g, 0.2468 mmol), dimethylsulfoxide (DMSO) (177 g) and toluene (100 mL) were combined in the reaction flask under nitrogen and immersed into a hot oil bath (140° C.). (Warning: If bisphenol-S is added at 170° C. a very intense gas evolution/foaming occurs leading to an uncontrollable situation.) Under mechanical stirring the mixture was slowly heated to 170° C. over the course of 7 hours. Toluene/water was distilled off and the progress of the polymerization was monitored by GPC. After 9 h, a constant weight average molecular weight of approximately 4,700 was reached. The mixture was cooled to room temperature and bisphenol S, bis(4-hydroxyphenyl)sulfone, (24.6847 g, 98.6303 mmol), 2,6-difluorobenzonitrile (16.0088 g, 115.0848 mmol) and more toluene were added to the mixture. The mixture was slowly heated back to 170° C. to make sure the distillation of toluene/water was not too vigorous. After the addition of the second pair of monomers the molecular weight slightly dropped but then immediately sharply increased until it leveled off at around Mw=65,000 (PDI=4.9).

The polymerization mixture was cooled and diluted with DMSO (343 mL) and then precipitated into water (2×2000 mL), filtered, rinsed with water and air dried for 24 hours. After vacuum oven dried at 70° C. for three days a fluffy powder was obtained (60.5 g).

### DSC: T_{g}=212° C.

Contact angle: 72° (top); 31° (facing glass)

### Example 6

### Random Copolymer

Under nitrogen atmosphere into a 500 mL-reactor, bisphenol-S (19.176 g, 84 mmol) and BPA (9.010 g, 36 mmol) were added, which was followed by the addition of tetramethylene sulfone (95 mL), toluene (100 ml), and K₂CO₃ (24.9 g, 180 mmol). The reaction mixture was heated at 180° C. for 8 h to distill the toluene. Bis(4-chlorophenyl)sulfone (20.676 g, 72 mmol) and difluorobenzonitrile (6.677 g, 48 mmol) were added. The reaction temperature was increased to 210° C. After 15 h, the Mw=56 k (PDI=3.8) was high enough and the mixture was diluted with DMAc (150 mL). The solution was precipitated in water, and rinsed with water. The resulting white fluffy powder was reslurried with water, filtered and slurried again with methanol. After filtration and drying in the vacuum oven a fluffy white powder was obtained.

### DSC: T_{g}=199° C.

Contact angle: 72° (top); 39° (facing glass)

### Example 7

### Random Copolymer

Under nitrogen atmosphere into a 500 mL-reactor, bisphenol-S (18.019 g, 72 mmol) and BPA (10.958 g, 48 mmol) were added, which was followed by the addition of tetramethylene sulfone (80 mL), toluene (100 ml), and K₂CO₃ (24.9 g, 180 mmol). The reaction mixture was heated at 180° C. for 8 h to distill the toluene. Bis(4-fluorophenyl)sulfone (9.153 g, 36 mmol) and difluorobenzonitrile (11.685 g, 84 mmol) were added. The reaction temperature was increased to 220° C. After 15 h, the Mw=40 k (PDI=2.6) was reached and the mixture was diluted with DMAc (150 mL). The solution was precipitated in water, and rinsed with water. The resulting white fluffy powder was reslurried with water, filtered and slurried again with methanol. After filtration and drying in the vacuum oven a fluffy white powder was obtained.

### DSC: T_{g}=209° C.

Contact angle: 70° (top); 35° (facing glass)

Polymer samples 1-5 were fabricated into flat sheet membranes and tested for contact angle.

Samples #1 through #4 are copolymers using “hydrophobic monomers” (Bisphenol-A, BPA & dichlorodiphenyl sulfone, DCDPS) and “hydrophilic monomers” (Bisphenol-S, BPS & 2,6-difluorobenzonitrile, DFBN). Polymers #1 and #2 were polymerized in a stepwise manner so that block copolymers were obtained featuring hydrophobic and hydrophilic blocks as evidenced by NMR spectroscopy. Samples #3 and #4 have the same monomer composition as #1 and #2, respectively. However the hydrophobic and hydrophilic monomers in the polymer chain were arranged randomly.

The following table is a summary of representative monomer composition, polymer architectures and contact angles:

| | Sample | | | | | |
|---|---|---|---|---|---|---|
| | #1 | #2 | #3 | #4 | #5 | #6 |
| Architecture | Block | Block | Random | Random | Random | Blend |
| | | | | | | (1/1) |
| BPA | 70% | 40% | 70% | 40% | — | — |
| BPS | 30% | 60% | 30% | 60% | 100% | 100% |
| DCDPS | 60% | 30% | 60% | 30% | — | 50% |
| DFBN | 40% | 70% | 40% | 70% | 100% | 50% |
| Hydrophobic | 8,500 | 4,600 | — | — | — | — |
| block Mw | | | | | | |
| End Mw | 190,000 | 64,000 | 56,000 | 40,000 | 80,000 | — |
| T_{g} [° C.] | 202 | 212 | 199 | 209 | 225 | 224 (est) |
| Contact | 46° | 31° | 40-50° | 30-40° | 30-40° | |
| angle | | | | | | |

### Example 8

Wet flat-sheet polyarylether microporous membrane of Example 1 was dissolved in NMP at 20% solids and cast on a non-woven polyester support, then submersed in a water-isopropanol bath at room temperature to produce a supported microporous membrane. The fiber supported membrane was placed between two 20.5 cm×28.0 cm aluminum frames with excess water removed from the surface. Onto the surface of this membrane was gently poured 100 ml of a 2.2 wt % aqueous meta-phenylenediamine (mPD) solution and allowed to soak for 30 seconds. The solution was poured off the membrane and the surface wiped free of residual droplets. The resulting mPD-impregnated membrane was gently treated with, 70 ml of a 0.10 wt % solution of 1,3,5-trimesoyl chloride in Isopar G™ and allowed to soak for 30 seconds. The solution was then gently poured from the membrane and allowed to drain. The membrane was dried at 95° C. for 4 minutes. The resulting RO composite membrane will possess a sodium chloride rejection of 90-99.5% and an A-value of 15 to 2 cm/sec-atm.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A water filtration apparatus comprising a polyarylethernitrile membrane having structural units of formula 1 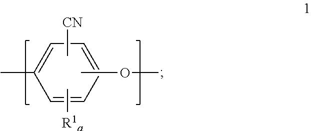
and
structural units of formula 2, 3, or a combination thereof 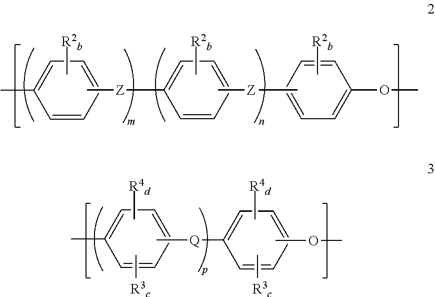
wherein
Z is independently a direct bond, O, S, CH₂, SO, SO₂, CO, RPO, CH₂, alkenyl, alkynyl, a C₁-C₁₂ aliphatic radical, a C₆-C₁₂ cycloaliphatic radical, a C₆-C₁₂ aromatic radical or a combination thereof, and wherein R is equal to C₆-C₁₂ aryl radical;
Q is a direct bond, O, S, CH₂, alkenyl, alkynyl, a C₁-C₁₂ aliphatic radical, a C₃-C₁₂ cycloaliphatic radical, a C₆-C₁₂ aromatic radical or a combination thereof;
R¹, R², R³ and R⁴ are independently H, halo, nitro, a C₁-C₁₂ aliphatic radical, a C₃-C₁₂ cycloaliphatic radical, a C₆-C₁₂ aromatic radical, or a combination thereof;
a is 0, 1, 2 or 3;
b, c, and d are independently 0, 1, 2, 3 or 4; and
p, m and n are independently 0 or 1; and
Q and Z are different.

2. The water filtration apparatus according to claim 1, wherein the polyarylethernitrile comprises structural units of formula 1A with structural units of formula 2A, 3A, or a combination thereof

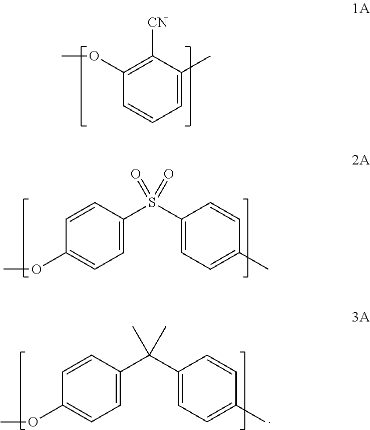

3. The water filtration apparatus according to claim 1, wherein the polyarylethernitrile comprises structural units of formula I 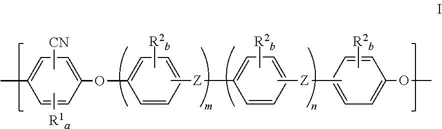
wherein Z is a direct bond, O, S, CH₂, SO, SO₂, CO, phenylphosphine oxide or a combination thereof;
R¹ and R² are independently H, halo, cyano, nitro, a C₁-C₁₂ aliphatic radical, a C₃-C₁₂ cycloaliphatic radical, a C₆-C₁₂ aromatic radical, or a combination thereof;
a is 0, 1, 2 or 3;
b is 0, 1, 2, 3 or 4; and
m and n are independently 0 or 1.

4. The water filtration apparatus according to claim 1, having a flat sheet configuration.

5. A method for water purification said method comprising:
contacting a feed stream with a membrane comprising at least one polyarylethernitrile having structural units of formula 1 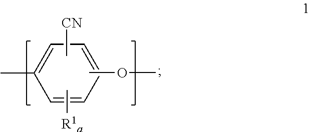
and
structural units of formula 2, 3, or a combination thereof 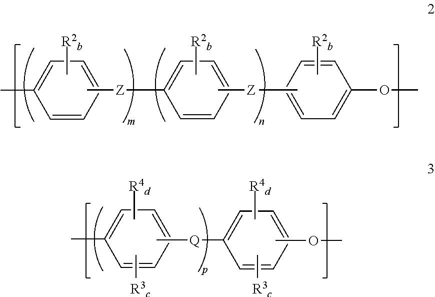
wherein
Z is independently a direct bond, O, S, CH₂, SO, SO₂, CO, RPO, CH₂, alkenyl, alkynyl, a C₁-C₁₂ aliphatic radical, a C₆-C₁₂ cycloaliphatic radical, a C₆-C₁₂ aromatic radical or a combination thereof, and wherein R is equal to C₆-C₁₂ aryl radical;
Q is a direct bond, O, S, CH₂, alkenyl, alkynyl, a C₁-C₁₂ aliphatic radical, a C₃-C₁₂ cycloaliphatic radical, a C₆-C₁₂ aromatic radical or a combination thereof;
R¹, R², R³ and R⁴ are independently H, halo, nitro, a C₁-C₁₂ aliphatic radical, a C₃-C₁₂ cycloaliphatic radical, a C₆-C₁₂ aromatic radical, or a combination thereof;
a is 0, 1, 2 or 3;
b, c, and d are independently 0, 1, 2, 3 or 4; and
p, m and n are independently 0 or 1; and
Q and Z are different; and
collecting water as a permeate.

6. The method according to claim 5, wherein the polyarylethernitrile comprises structural units of formula 1A with structural units of formula 2A, 3A, or a combination thereof

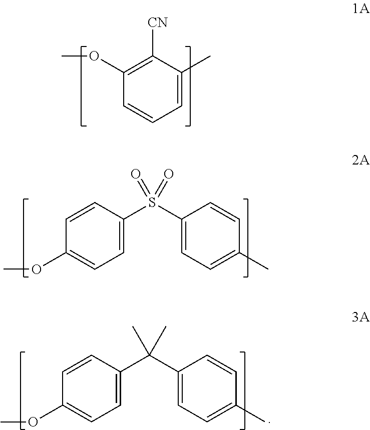

7. The method according to claim 5 wherein the polyarylethernitrile comprises structural units of formula I 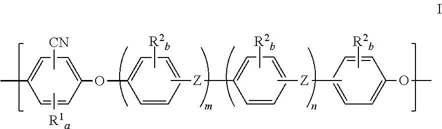
wherein Z is a direct bond, O, S, CH₂, SO, SO₂, CO, phenylphosphine oxide or a combination thereof;
R¹ and R² are independently H, halo, cyano, nitro, a C₁-C₁₂ aliphatic radical, a C₃-C₁₂ cycloaliphatic radical, a C₆-C₁₂ aromatic radical, or a combination thereof;
a is 0, 1, 2 or 3;
b is 0, 1, 2, 3 or 4; and
m and n are independently 0 or 1.

8. The method according to claim 7 wherein the feed stream comprises brackish water, sea water, industrial water for electronic, pharmaceutical, or food contact applications, or industrial waste water.

9. The method according to claim 8 wherein the feed stream comprises brackish water or seawater, and the permeate is desalinated water.

10. A water filtration apparatus comprising:
a first membrane comprising at least one membrane comprising a polyarylethernitrile having structural units of formula 1 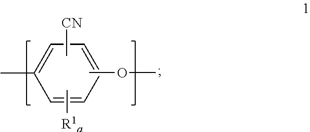
and
structural units of formula 2, 3, or a combination thereof 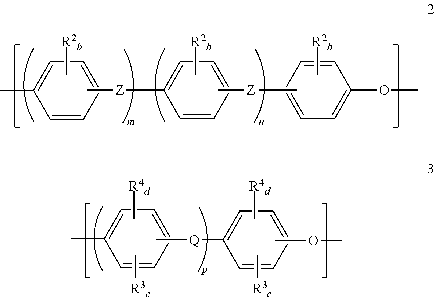
wherein
Z is independently a direct bond, O, S, CH₂, SO, SO₂, CO, RPO, CH₂, alkenyl, alkynyl, a C₁-C₁₂ aliphatic radical, a C₆-C₁₂ cycloaliphatic radical, a C₆-C₁₂ aromatic radical or a combination thereof, and wherein R is equal to C₆-C₁₂ aryl radical;
Q is a direct bond, O, S, CH₂, alkenyl, alkynyl, a C₁-C₁₂ aliphatic radical, a C₃-C₁₂ cycloaliphatic radical, a C₆-C₁₂ aromatic radical or a combination thereof;
R¹, R², R³ and R⁴ are independently H, halo, nitro, a C₁-C₁₂ aliphatic radical, a C₃-C₁₂ cycloaliphatic radical, a C₆-C₁₂ aromatic radical, or a combination thereof;
a is 0, 1, 2 or 3;
b, c, and d are independently 0, 1, 2, 3 or 4; and
p, m and n are independently 0 or 1; and
Q and Z are different; and
a second membrane deposited on the surface of the first membrane and having a thickness of about 1 to about 500 nanometers.

11. The water filtration apparatus according to claim 10, wherein the polyarylethernitrile comprises structural units of formula 1A with structural units of formula 2A, 3A, or a combination thereof

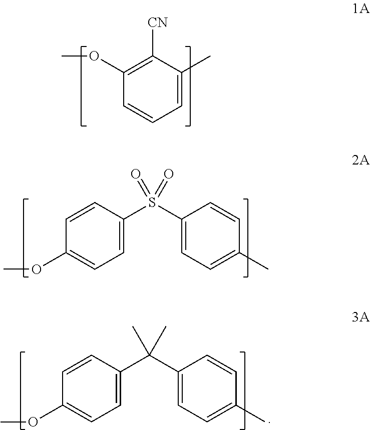

12. The water filtration apparatus according to claim 10, wherein the polyarylethernitrile comprises structural units of formula I 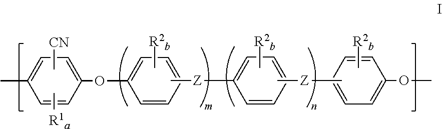
wherein Z is a direct bond, O, S, CH₂, SO, SO₂, CO, phenylphosphine oxide or a combination thereof;
R¹ and R² are independently H, halo, cyano, nitro, a C₁-C₁₂ aliphatic radical, a C₃-C₁₂ cycloaliphatic radical, a C₆-C₁₂ aromatic radical, or a combination thereof;
a is 0, 1, 2 or 3;
b is 0, 1, 2, 3 or 4; and
m and n are independently 0 or 1.

13. The water filtration apparatus according to claim 10 wherein the second membrane is deposited on the first membrane using interfacial polymerization.

14. The water filtration apparatus according to claim 13 wherein the second membrane comprises the condensation product of an electrophilic monomer and a nucleophilic monomer.

15. The water filtration apparatus according to claim 14 wherein the electrophilic monomer comprises trimesoyl chloride, trimellitic acid trichloride, terephthaloyl chloride, isophthaloyl chloride, 5-isocyanato isophthaloyl chloride, 5-chloroformyloxy isophthaloyl chloride, 5-chloro sulfonyl isophthaloyl chloride, 1,3,6-(trichlorosulfonyl)naphthalene, 1,3,7-(trichlorosulfonyl)napthalene, 1,3,5-trichlorosulfonyl benzene or a combination thereof.

16. The water filtration apparatus according to claim 14 wherein the nucleophilic monomer or monomers comprises m-phenylenediamine, p-phenylenediamine, 1,3,5-triaminobenzene, piperazine, 4-aminomethylpiperidine, and either individually or a combinations thereof.

17. The water filtration apparatus according to claim 10 wherein the first and second membrane are treated with an aqueous hypoclorite solution.

18. A method for reverse osmosis water purification said method comprising:
contacting a feed stream with an apparatus comprising:
a first membrane comprising at least one membrane comprising a polyarylethernitrile having structural units of formula 1 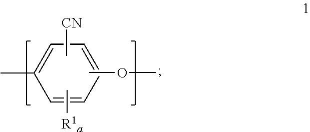
and
structural units of formula 2, 3, or a combination thereof 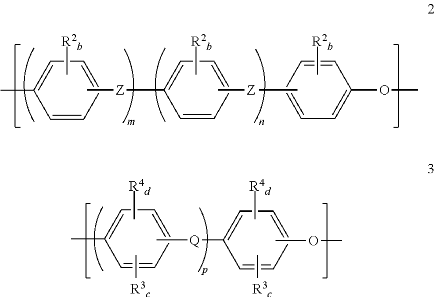
wherein
Z is independently a direct bond, O, S, CH₂, SO, SO₂, CO, RPO, CH₂, alkenyl, alkynyl, a C₁-C₁₂ aliphatic radical, a C₆-C₁₂ cycloaliphatic radical, a C₆-C₁₂ aromatic radical or a combination thereof, and wherein R is equal to C₆-C₁₂ aryl radical;
Q is a direct bond, O, S, CH₂, alkenyl, alkynyl, a C₁-C₁₂ aliphatic radical, a C₃-C₁₂ cycloaliphatic radical, a C₆-C₁₂ aromatic radical or a combination thereof;
R¹, R², R³ and R⁴ are independently H, halo, nitro, a C₁-C₁₂ aliphatic radical, a C₃-C₁₂ cycloaliphatic radical, a C₆-C₁₂ aromatic radical, or a combination thereof;
a is 0, 1, 2 or 3;
b, c, and d are independently 0, 1, 2, 3 or 4; and
p, m and n are independently 0 or 1; and
Q and Z are different; and
a second membrane deposited on the surface of the first membrane and having a thickness of about 1 to about 500 nanometers; and
collecting water as a permeate.

19. The method according to claim 18, wherein the polyarylethernitrile comprises structural units of formula 1A with structural units of formula 2A, 3A, or a combination thereof

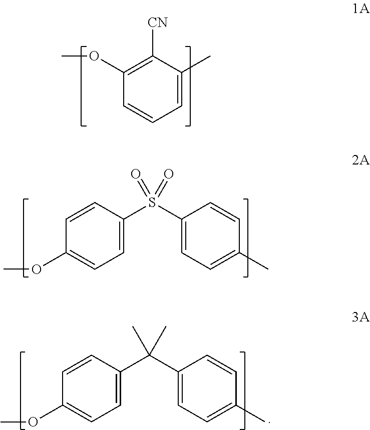

20. The method according to claim 18 wherein the polyarylethernitrile comprises structural units of formula I 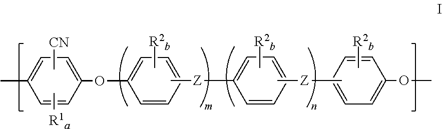
wherein Z is a direct bond, O, S, CH₂, SO, SO₂, CO, phenylphosphine oxide or a combination thereof;
R¹ and R² are independently H, halo, cyano, nitro, a C₁-C₁₂ aliphatic radical, a C₃-C₁₂ cycloaliphatic radical, a C₆-C₁₂ aromatic radical, or a combination thereof;
a is 0, 1, 2 or 3;
b is 0, 1, 2, 3 or 4; and
m and n are independently 0 or 1.

21. The method according to claim 18 wherein the second membrane comprises a condensation product of an electrophilic monomer and a nucleophilic monomer.

22. The method according to claim 21 wherein the electrophilic monomer comprises trimesoyl chloride, trimellitic acid trichloride, terephthaloyl chloride, isophthaloyl chloride, 5-isocyanato isophthaloyl chloride, 5-chloroformyloxy isophthaloyl chloride, 5-chloro sulfonyl isophthaloyl chloride, 1,3,6-(trichlorosulfonyl)naphthalene, 1,3,7-(trichlorosulfonyl)napthalene, 1,3,5-trichlorosulfonyl benzene or a combination thereof.

23. The method according to claim 21 wherein the nucleophilic monomer or monomers comprises m-phenylenediamine, p-phenylenediamine, 1,3,5-triaminobenzene, piperazine, 4-aminomethylpiperidine, and either individually or a combinations thereof.

24. The method according to claim 18 wherein the first and second membrane are treated with an aqueous hypochlorite solution.

25. The method according to claim 18 wherein the feed stream comprises brackish water, sea water, industrial water for electronic, pharmaceutical, or food contact applications, or industrial waste water.

26. The method according to claim 25 wherein the feed stream comprises brackish water or seawater and the permeate is desalinated water.
